(19) United States
(12) Patent Application Publication
(10) Pub. No.: US 2020/0152049 A1
(43) Pub. Date: May 14, 2020

(54) Mouth Activated Controller

(71) Applicant: Shawn Keith McConnell, Hixson, TN (US)

(72) Inventor: Shawn Keith McConnell, Hixson, TN (US)

(21) Appl. No.: 16/658,847

(22) Filed: Oct. 21, 2019

Related U.S. Application Data
(60) Provisional application No. 62/760,459, filed on Nov. 13, 2018.

(51) Int. Cl. G08C 17/02; H04B 1/034; G01L 1/22; G05B 19/409; G05G 1/52

(52) U.S. Cl. CPC G08C 17/02; H04B 1/034; G01L 1/225; G05B 2219/45135; G05G 1/52; G05B 2219/45129; G05B 19/409

(57) ABSTRACT

A mouth activated controller can be useful for operating equipment such as welders, drills and other equipment which may have traditionally utilized other controllers in the past, like foot controllers, etc. The mouth controller could operate in a live mode such as based on the pressure applied to a mouth pad, such as through teeth, or a step mode whereby a number of bites controls operation of the equipment for at least some embodiments.

The present application claims priority to U.S. Provisional Patent Application No. 62/760,459 filed Nov. 13, 2018.

### FIELD OF THE INVENTION

The present invention relates to a mouth activated controller for use with industrial equipment such as welders and/or other equipment traditionally controlled by foot pedals or other controllers and method of its use.

### BACKGROUND OF THE INVENTION

Welding equipment such as TIG welders have been made for years by Lincoln, Miller, ESAB and other companies. Improvements to basic foot pedal controllers include U.S. Pat. No. 9,302,340 which relates to a wireless foot controller. Finger control mechanisms such as 9,550,250 have also been introduced. Each of these prior designs is believed to have disadvantages.

Specifically, foot control pedals require a foot to be in position to control the pedal. When one is welding on their back, welding above their heads, or in other awkward positions, foot pedals may be difficult or awkward to operate.

Finger controllers may not be as limited in some applications as foot control pedals, but trying to precisely locate the tip of a hand tool of a welder in a specific position while maneuvering one's finger with that same hand to provide on-the-fly adjustment of weld settings, may prove too much of a challenge in dexterity for some people for at least some applications.

Accordingly, improved methods and equipment for controlling welders and/or other tools or machinery may be desirable for at least some parties or applications.

### SUMMARY OF THE INVENTION

It is a present object of many embodiments of the present invention to provide an improved controller for use with industrial applications.

It is another object of many embodiments of the present invention to provide a mouth activated controller.

It is a present object of many embodiments of the present invention to provide an improved mouth activated or mouth pad controller which for some embodiments which may including turning industrial equipment on and off, as well as potentially controlling the operation of at least some industrial equipment or tools over an operational range.

It is a present object of many embodiments of the present invention to provide a mouth activated controller capable of controlling a welder over a range of operation such as between 2 and 200 amps, or other range(s).

It is a present object of many embodiments of the present invention to provide an improved mouth activated controller for controlling tools, or equipment, over a range of operation as well as potentially having the capability to select between sensitivity of applied pressure control over that range.

It is a present object of many embodiments of the present invention to provide an improved mouth activated controller for providing at least one of analog pressure control and/or possibly digital control such as through stepping control steps or otherwise.

Accordingly, in accordance with at least some presently preferred embodiments of the present invention, a mouth activated controller is provided, possibly for one or multiple applications. In some applications, the mouth activated controller controls the operation of a welder such as a welder manufactured by Lincoln, Miller, ESAB or other welder manufacturers. Many of these welders such as TIG welders, have a cannon plug which is often plugged into a foot controller to control the operation of the welder.

Instead of using a foot controller, the applicant is providing a mouth activated controller. The mouth activated controller can have either plug with a wire connection as with a cannon plug of the welder, or utilize a wireless style controller possibly not completely different than that shown in U.S. Pat. No. 9,302,340 as it relates to the receiver unit plugging into the cannon plug of the welding unit. However, instead of having a foot wireless foot pedal as shown and described in that reference, the applicant could provide a wireless mouth controller where the mouth activated or mouth pad is received in the mouth of the user so that as a user bites down, or otherwise applies pressure, on at least one of a mouth activated or mouth pad, a pressure is applied not in a dissimilar manner as pressure could be applied to a foot pedal.

For wireless operations a wire may run from the mouth activated or mouth pad to a wireless transmitter which could be retained to or around the user in various ways such as in the pocket of a user, attached to the user, and/or attached to the welding helmet of the user or otherwise located as would be understood by those of ordinary skill in the art. The transmitting unit may have a three position selector switch to select the sensitivity of the mouth pad or mouth activated pressure sensor which could include an FSR pressure sensor or other appropriate pressure sensor which could then provide information to a potentiometer such as digital potentiometer and to provide information to an Arduino board or other appropriate computing device (such as a programmable logic controller, microcomputer and/or other device) and/or transmitter to then transmit the data to the receiving unit and/or welder. Digital to analog converters could be used, possible with or instead of digital potentiometers. Other devices could be used with other embodiments.

Welding normally can occur over a range of current and voltage. Other industrial applications may operate differently. For instance, a dentist could instead of utilizing a foot controller to control an air driven drill, could instead utilize a similar mouth activated controller for controlling that air driven drill. Certainly, there are other industrial applications that could have similar capabilities with the mouth activated controller of the presently preferred embodiment.

### BRIEF DESCRIPTION OF THE DRAWINGS

The particular features and advantages of the invention as well as other objects will become apparent from the following description taken in connection with the accompanying drawings in which:

FIG. 1 is a front perspective view of a welder using the presently preferred embodiment of the present invention;

FIG. 2 is a side plan view of the welder of FIG. 1 with the welding helmet up with the present invention still in his/her mouth;

FIG. 3 shows a mouth pad of the presently preferred embodiment of the present invention inserted in a sleeve and then inserted in the mouth of the user as in FIG. 1 and FIG. 2;

FIG. 4 shows the mouth pad received within a mouth activated which could also have the sleeve in FIG. 3 if so desired, or not;

FIG. 5 shows a welding unit with a receiver to communicate with signals with the mouth activated of FIGS. 1 and 2 if not wired directly;

FIG. 6 shows a transmitter of FIG. 1 in cross-sectional form;

FIG. 7 is a schematic representation of a transmitter utilized with at least some presently preferred embodiments of the present invention; and

FIG. 8 is a schematic representation of a receiver utilized with at least some presently preferred embodiments of the present invention.

### DETAILED DESCRIPTION OF THE PREFERRED EMBODIMENTS

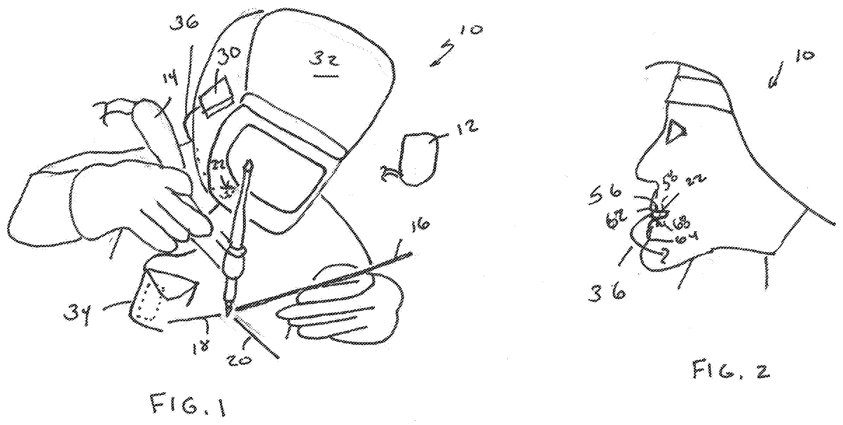

FIG. 1 shows a tool and/or industrial equipment of the presently preferred embodiment of the invention in the form of welder such as a TIG welder 12 connected to handpiece 14 as would be understood by those of ordinary skill in the art. Normally, the user or welder 10 would step on a foot pedal to control the amount of current and/or voltage applied to the handpiece 14 to provide the desired weld with a consumable 16 between one or more workpieces 18,20. TIG welder 10 is shown, however MIG welding and/or traditional welding equipment could also be utilized whether in a protected inert gas environment or not.

Additionally, although welding is shown as a use of the presently preferred embodiment of the present invention, other uses could apply as well such as to any of a variety of industrial equipment and/or tools. Instead of having a foot pedal (or other controller) or in addition to a foot pedal (or other controller) to control the tool or welder 12 presently preferred embodiment of the invention provide a mouth control device 22 which could be provided somewhat as an insert 24 and/or a mouth activator 26 and/or a mouth pad 38 possibly having a sleeve 28 thereabout as will be explained in further detail below.

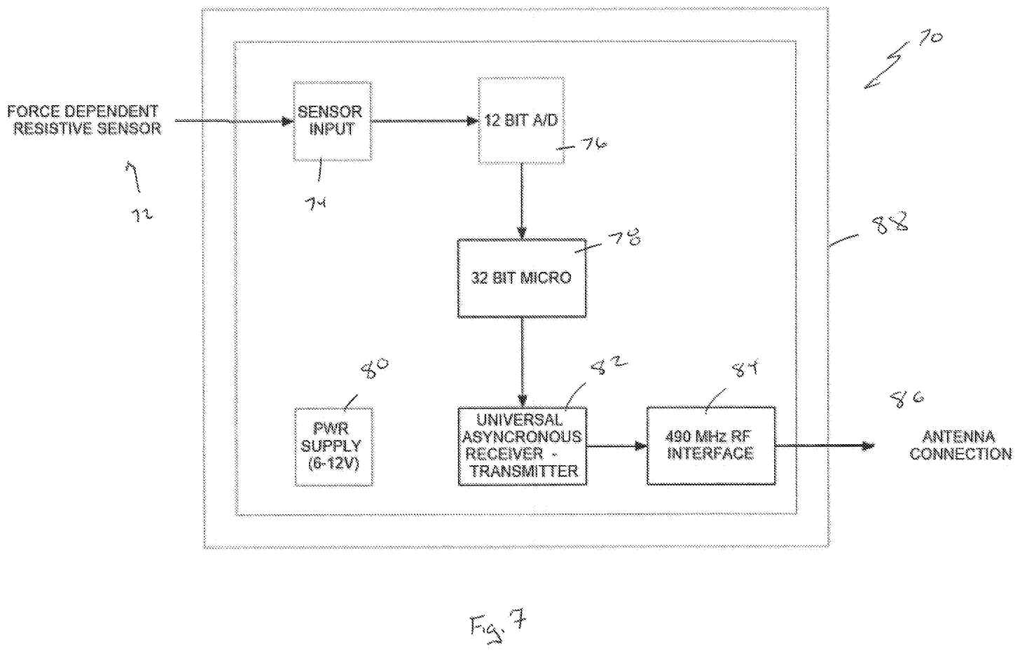

Mouth control device 22 is preferably connected such as wired to a transmitter 30 which could be located in various locations whether be connected to a welding helmet 32 or located in a pocket 34 or otherwise provided in a convenient location. Of course, the wire 36 from the mouth control device could be directed to the welder 12 as shown in FIG. 5 so that wireless communication from the mouth control device 22 to the welder 12 would not necessarily be provided for all embodiments (i.e., a wired connection could be provided) but certainly could be for some. The mouth control device 22 whether it be a pad 38 and/or in the form of a mouth activator 26 preferably comprises a pressure sensor 72 such as an FSR so as to be able to sense an increase in pressure and provide at least one of an analog and digital signal to a processor 40 possibly in combination with a potentiometer 42 and/or a transmitter 44, possibly also using an Arduino board 46 or other processor as would be understood by those of ordinary skill in the art.

At least some of the electronics could be housed within a housing 48 so that upon receipt of a specific signal a corresponding and/or correlating signal could be sent from the transmitter unit 30 to a receiving unit 50 if not hardwired through connection 36 to the welder 12 for operation.

In operation, the user 10 can bite down, i.e., between opposing body parts, such as directly in contact with those body parts, i.e., with the pad 38 and/or sleeve 28, such as upper and lower teeth 58,60, and/or other body portions to apply pressure to the mouth control device 22 thereby providing a signal to the processor 40 and or 46 for use in controlling the equipment or welder 12.

One exemplary way could be to preset the welder 12 between a range of applied amperage/voltages such as between 2 amps and 200 amps depending on the amount of pressure applied to the mouth control device 22. Presets could be dialed in with dial 52 or otherwise set and then potentially displayed on display 54, if visible, and/or otherwise provided through the welder 12 or other appropriate equipment.

Remember, the welder 12 is just one piece of industrial equipment that the mouth control device 22 can operate through. There may be other applications such as a dentist utilizing the mouth control device 22 to control an air driven drill. Still other applications may apply to such as industrial or other controlled machinery or equipment, tools, etc., particularly if an operator lacks a leg. There may be other tools which may benefit from the use of this type controller either due to the awkward positioning of the worker 10 utilizing a specific tool, the convenience of the worker 10 and/or the preference of the worker 10 or other use.

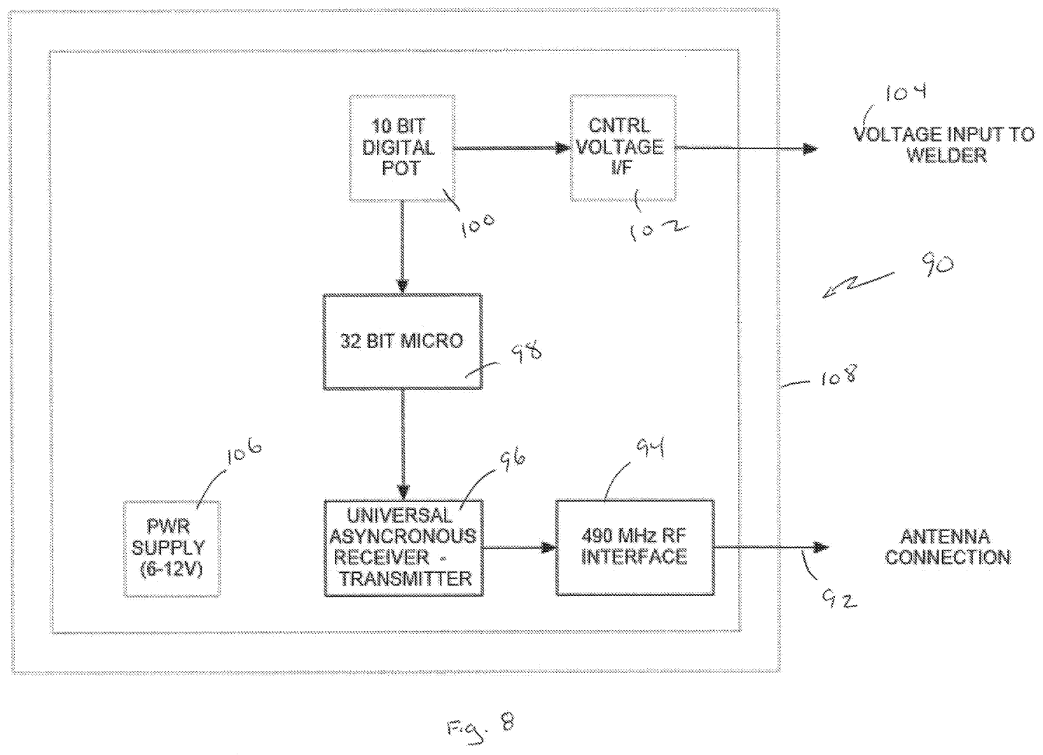

FIG. 2 shows worker 10 with the mouth control device 22 in his or her mouth 56 which would be understood by those skilled in the art that if the mouth control device 22 is an analog type device then the mouth pressure is between the worker's teeth 58, 60 and or lips 62,64 may control the operation of the equipment such as welder 12. Although it may be that the transmitter 30 may be embedded within the mouth activator 26 for future versions, it is more likely that the unit 30 will be separate from the mouth activator 26 for at least some embodiments such as transmitter 70 illustrated in FIG. 7.

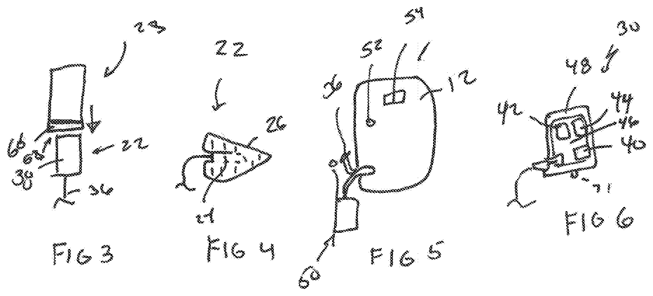

FIG. 3 shows the mount control device 22 in the form of a mouth pad 38 which may have a protective sleeve 28 installed thereabout. This way, multiple parties can utilize the same mouth pad 38 in a relatively sanitary manner by swapping out the sleeve 28 which could be a disposable. Effectively, sleeve 28 could be somewhat of a structure similar to a plastic bag, possibly having a zip connection 66 at end 68 so that the sleeve 60 which might encapsulate the pad 38 possibly with the wire 36 extending therefrom, preferably in a watertight manner. Mouth pad 38 of FIG. 3, either with or without the sleeve 28 could then be inserted and/or formed into a mouth activated 26 particularly if a single user is going to utilize the mouth control device 22 such as is shown in FIG. 4 or otherwise.

For some operations welder 10 may be a user which can bite down once to energize the welder 12, it may then be that one of a number of positions could be selected by the user 10 by biting down one, two or three times to select one of three different possible preset settings or otherwise on the welder 12 to therefore select the sensitivity and/or predetermined range of operation. Other settings might be selected in a similar or dissimilar manner. The mouth control device 22 could be either analog or digitally operated as would be of interest by those of various skill in the art. For digital operation it may be that each bite triggers a different range and/or a different location or step within a specific range as compared to for analog the amount of pressure applied may dictate a specific location within a range of operation. Additionally, in an alternative embodiment, a switch 70 may be utilized such as on the housing 48 otherwise to select a particular sensitivity and/or mode of operation of the mouth control device 22. On/off toggling of one or more switches may be achieved with various mouth control devices 22 as well in addition to operating equipment over a range based upon applied pressure and/or other mouth applied input.

Although the preferred embodiments are used with a user's mouth, other embodiments could be operated by other portions of a user's body. For instance, a toe could operate a device like a mouth pad 22 connected to a sock or possibly in a shoe, or boot. Other portions of the body, other than toes, could be employed for still further embodiments, preferably with the device connection to, or at least retained to, with and/or by the user's body.

FIG. 7 shows a transmitter 7 that can be utilized with the mouth pad 38 which could include the force dependent resistant sensor 72 or other appropriate sensor which provides sensor input 74 which can be received from a 12 bit analog to digital converter 76 or possibly other appropriate converter to then provide to a processor 78 such as a 32-bit microprocessor which could then provide data to a receiver/transmitter 82 such as a universally synchronized receiver/transmitter 82 to then provide a signal to an interface 84 such as a 490 megahertz radio frequency interface or other appropriate interface and an antenna connection 86 to potentially wirelessly transmit data from the transmitter 70 to a receiver 90 based on the sensor input 74 received from the sensor 72.

A power supply 80 could power the transmitter 70 or other appropriate power supply could provide such transmission capability. Housing 88 may house the transmitter 70 as would be understood by one of ordinary skill in the art. Although a force dependent resistance sensor shown as sensor 72 or other sensor such as a force dependent sensor whether they be FSR's strain gauges, sip-puffs, (or any effective sensor device held in the mouth of a user) preferably in the form of a mouth pad or with the mouth pad possibly connected to a wire harness and a plug extended therefrom.

Coating for the sensor 72 could be EVA, silicone, or other suitable material that could be safely contained in the mouth of a user. The housing 88 may be secured to a user such as in a user's pocket on a user's belt or otherwise secured to a user as would be understood by those of ordinary skill in the art. The wire from the mouth pad 38 may be connected to the transmitter 70 for many embodiments.

FIG. 8 shows a receiver 90 in the form of an antenna connection 92 which can be connected to an interface 94 preferably a cooperating interface with interface 84 of the transmitter 70. Connected to the interface 94 may be a receiver/transmitter 96 such as a universal asynchronous receiver-transmitter which, if selected, is calculated to cooperate with a receiver/transmitter 82 of the transmitter 70. Connected to that structure may be a processor 98 such as a 32-bit micro-processor or otherwise and connected to the processor could be a digital potentiometer 100 such as 10-bit digital potentiometer illustrated which could provide a signal output or output signal through a controller such as voltage controller interface 102 which could provide a desired voltage input 104 to a welder or other appropriate equipment.

Power supply 106 may be provided for receiver 90. The receiver 90 may be contained preliminarily within housing 108 as illustrated or otherwise provided possibly even internal to selected compounds of industrial equipment whether it be drills, welders or other appropriate industrial equipment or possibly even other equipment whether it be household equipment or other appropriate equipment.

In operation, a user operator may apply force on the mouth piece such as mouth pad 38. The force applied can be processed and transmitted by the transmitter 70 to the receiver 90. The transmission may use zigby, Bluetooth, wi-fi, radio frequency or other appropriate protocols. The receiver 90 further receives data as sent from the transmitter 70.

The processor 98 in the receiver can use micro control/electronics in an algorithm to convert a signal that may trigger a relay, DAC, digital potentiometer 100, op-amp or other combination thereof to provide an output signal such as from interface 102 that may be usable by a welding machine as voltage input to the welder 104 or other machine (or equipment utilizing with other equipment).

An algorithm can have at least one, if not at least two, modes of operation. First a “live mode” can be provided where the output signal 104 of the welding machine as welding input 104 can follow true in real time inputs as received from the sensor input 74 based on inputs received at the sensor input 74. This could be utilized if the pressure as received at the sensor 72 in the amount of pressure is utilized to control the voltage input 104. A second mode of operation could be a step mode of operation where the operator may be able to click up the signal or through signals in increments to then potentially hold that signal steady until commanded to step down in increments such as by utilizing a number of force applications so bites or partial bites to the sensor 72 to “click” through various operation stages. Transmitter 88 may have a selection switch such as switch 71 to be utilized to change between modes of operations or otherwise. Switch 71 or other like it may also be utilized to change the sensitivity of the mouth control device 22 or provide still other functions.

A method of controlling equipment may comprise the steps of providing a pad, such as a mouth pad 38, and retaining the pad intermediate two portions of body of a user, such as between upper and lower sets of teeth, 58,60 in contact with the pad, said pad having a sensor 72 connected thereto, selectively applying a pressure with the portions of the body of the user, wherein, when pressure is applied to the pad, a sensor input 74 is generated and directed to a processor, 78 or 90 and said processor 98 providing an output signal at 102 to thereby control performance of the equipment, such as welder 10, based on the selective application of the control signal by the user.

For at least some embodiments a controller for use in controlling operation of equipment, such as a welder 10, or other equipment, having a pad, such as mouth pad 38 having a sensor 72 connected thereto, such as therein, a processor 78 and/or 98, with the sensor 72 detecting selective application of pressure to generate a sensor input 74 directed towards the processor, 78 and/or 98, said processor 78 and/or 98 coordinating a sensor output at 102 directed to equipment controlling the operation of the equipment

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the intention are intended to be included within the scope of the appended claims.

Having thus set forth the nature of the invention, what is claimed herein is:

1. A method of controlling equipment comprising the steps of:
providing a pad, and retaining the pad intermediate two portions of body of a user in contact with the pad, said pad having a sensor connected thereto;
selectively applying a pressure with the portions of the body of the user, wherein, when pressure is applied to the pad, a sensor input is generated and directed to a processor;
said processor providing an output signal to thereby control performance of the equipment based on the selective application of the control signal by the user.

2. The method of claim 1 wherein the pad is a mouth pad located in the mouth of a user.

3. The method of claim 2 wherein the application of pressure to the mouth pad is through biting on the mouth pad.

4. The method of claim 2 wherein the mouth pad is provided in a protective sleeve.

5. The method of claim 1 wherein the sensor is a pressure sensor.

6. The method of claim 5 wherein the pressure sensor is selected from the group of a force sensitive resistor, strain gauge, and a sip-puff switch, and an electro-mechanical switch.

7. The method of claim 1 wherein the processor has two modes of operation selected from a live mode whereby the output signal is proportional to the input signal, and a step mode whereby a number of input signals is proportion to the output signal.

8. The method of claim 1 further comprising a switch, said switch adjusting magnitude of the input signal based on a given pressure applied to the pad.

9. The method of claim 1 wherein the equipment is selected from the group of a welder and a drill, and the pad is used to control one of (a) an amount of voltage provided to the welder and (b) a speed of the drill.

10. The method of claim 1 wherein the input signal is received by a transmitter which wirelessly communicates with a receiver which generates the output signal.

11. The method of claim 1 wherein the input signal is one of a digital and an analog signal.

12. The method of claim 1 wherein the pad is hardwired to the equipment.

13. A controller for use in controlling operation of equipment comprising:
a mouth pad having a sensor connected thereto;
a processor in communication with the sensor;
said sensor detecting selective application of pressure to generate a sensor input directed towards the processor, said processor coordinating a sensor output directed to equipment controlling the operation of the equipment.

14. The controller of claim 13 wherein the application of pressure to the mouth pad is through biting on the mouth pad.

15. The controller of claim 13 wherein the processor has two modes of operation selected from a live mode whereby the output signal is proportional to the input signal, and a step mode whereby a number of input signals is proportion to the output signal.

16. The controller of claim 13 further comprising a switch, said switch adjusting magnitude of the input signal based on a given pressure applied to the pad.

17. The controller of claim 13 wherein the equipment is selected from the group of a welder and a drill, and the pad is used to control one of the amount of voltage provided to the welder and a speed of the drill.

18. The controller of claim 13 wherein the input signal is received by a transmitter which wirelessly communicates with a receiver which generates the output signal.

19. The controller of claim 13 wherein the input signal is one of a digital and analog signal.

20. The method of claim 13 wherein the sensor is a pressure sensor selected from the group of a force sensitive resistor, strain gauge, and a sip-puff switch, and an electro-mechanical switch.
